(19) United States
(12) Patent Application Publication
(10) Pub. No.: US 2014/0169161 A1
(43) Pub. Date: Jun. 19, 2014

(54) METHOD AND DEVICE FOR TRANSMITTING DATA

(71) Applicant: HUAWEI TECHNOLOGIES CO., LTD., Shenzhen (CN)

(72) Inventors: Gang WANG, Beijing (CN); Changzhou CHEN, Nanjing (CN); Weidong YIN, Shenzhen (CN)

(73) Assignee: HUAWEI TECHNOLOGIES CO., LTD., Shenzhen (CN)

(21) Appl. No.: 14/090,951

(22) Filed: Nov. 26, 2013

(30) Foreign Application Priority Data
Dec. 14, 2012 (CN) 201210543713.3

(51) Int. Cl. H04L 12/851

(52) U.S. Cl. CPC H04L 47/24
USPC 370/229

(57) ABSTRACT

The present invention discloses a method and a device for transmitting data. According to the technical solution provided by the present invention, no actual end-to-end multi-bearer connection is established between a terminal and a network side, but the terminal, when locally transmitting a data packet, simulates a multi-bearer mechanism to establish multiple virtual service channels on a bearer and performs priority-based scheduling between the service channels. Through virtual multi-bearer, the present invention can balance service QoS with resource utilization under the condition that the network or the terminal does not support the multi-bearer capability or the multi-bearer capability is restricted.

### CROSS-REFERENCE TO RELATED APPLICATIONS

This application claims priority to Chinese Patent Application No. 201210543713.3, filed on Dec. 14, 2012, which is hereby incorporated by reference in its entirety.

### TECHNICAL FIELD

The present invention relates to the field of communications, and in particular, to a method and a device for transmitting data.

### BACKGROUND

With continuous development of wireless and wired technologies, a communication bandwidth keeps increasing, thereby creating conditions for more diversified terminal applications, such as real-time games, streaming media, online applications, and cloud storage. Some applications, such as a voice call, do not have high bandwidth requirements but require continuous stability; whereas, some applications, such as a common download task, have relatively high bandwidth requirements but have no requirement on bandwidth stability. Although different applications have different bandwidth requirements, one common point for the applications is to occupy a maximum available bandwidth as far as possible. To make all the applications coexist and obtain an appropriate bandwidth to achieve optimal user experience, the wireless access technology introduces technologies such as multi-bearer and multi-access point name (Access Point Name, APN), so that a high-priority service preferentially uses limited wireless resources to enhance the quality of service (Quality of Service, QoS).

Characteristics of multi-bearer lie in resource pre-allocation and priority-based utilization. However, upgrading of a system device undergoes a process and multiple services still need to be transmitted on one bearer as some networks or terminals do not support a multi-bearer capability or the multi-bearer cannot completely meet the requirements of multiple services. The QoS of the services transmitted on one bearer is difficult to distinguish. In the prior art, to obtain better user experience, one way is to avoid interference to the services having high real-time requirements by shutting other services, but this way may cause limitations on applications; the other way is to apply for a greater bandwidth by a user, but this way may cause waste of bandwidth resources.

To conclude, in the prior art, a multi-bearer network or terminal not supporting the multi-bearer capability is difficult to balance user experience with resource utilization when transmitting multiple services.

### SUMMARY OF THE INVENTION

Embodiments of the present invention provide a method and a device for transmitting data to balance relatively good user experience with appropriate resource utilization under the condition that a network or terminal does not support a multi-bearer capability.

In a first aspect, the application provides a method for transmitting data, including:

when a service is started, constructing, by a terminal, a virtual traffic flow template TFT by using service information, and mapping, by using the virtual TFT, a data packet of the service to a virtual bearer corresponding to the virtual TFT;

setting, by the terminal, a priority of the virtual bearer according to a priority of the service;

transmitting, by the terminal, the data packet to a network device on an actual bearer according to the priority of the virtual bearer.

In a first possible implementation manner of the first aspect, the service information is at least one of information about a port for receiving the service and the priority of the service.

With reference to the first aspect or the first possible implementation manner of the first aspect, in a second possible implementation manner, the transmitting, by the terminal, the data packet to a network device on an actual bearer according to the priority of the virtual bearer includes:

queuing, by Layer 2 of the terminal, the data packet in a bearer queue of the actual bearer according to the priority of the virtual bearer to obtain a queued data packet, and transmitting the queued data packet to the physical layer, to enable a high-priority data packet preferentially transmitted to a network device at the physical layer.

With reference to the second possible implementation manner of the first aspect, in a third possible implementation manner, the queuing, by Layer 2 of the terminal, the data packet in a bearer queue of the actual bearer according to the priority of the virtual bearer includes:

queuing, by a Packet Data Convergence Protocol PDCP layer or radio link control RLC layer at Layer 2, the data packet in a bearer queue of the actual bearer according to the priority of the virtual bearer.

With reference to the third possible implementation manner of the first aspect, in a fourth possible implementation manner, before transmitting the queued data packet to the physical layer, the method further includes: postponing an encryption operation of the PDCP or RLC layer at Layer 2 to be performed at the media access control MAC layer.

In a second aspect, the application provides a terminal device for transmitting data, including:

a constructing module, configured to, when a service is started, construct a virtual traffic flow template TFT by using service information, and mapping, by using the virtual TFT, a data packet of the service to a virtual bearer corresponding to the virtual TFT;

a priority setting module, configured to set the priority of the virtual bearer according to the priority of the service; and

a transmitting module, configured to transmit the data packet to a network device according to the priority of the virtual bearer set by the priority setting module.

In a first possible implementation manner of the second aspect, the service information is at least one of information about a port for receiving the service and the priority of the service.

With reference to the second aspect or the first possible implementation manner of the second aspect, in a second possible implementation manner, the transmitting module includes:

a Layer-2 unit, configured to queue the data packet in a bearer queue of the actual bearer according to the priority of the virtual bearer to obtain a queued data packet, and transmit the queued data packet to the physical layer, to enable a high-priority data packet preferentially transmitted to a network device at the physical layer.

With reference to the second possible implementation manner of the second aspect, in a third possible implementation manner, the Layer 2 unit is specifically configured to queue, by a Packet Data Convergence Protocol PDCP layer or radio link control RLC layer of the Layer 2 unit, the data packet in a bearer queue of the actual bearer according to the priority of the virtual bearer to obtain a queued data packet, and transmit the queued data packet to the physical layer, to enable a high-priority data packet preferentially transmitted to a network device at the physical layer.

With reference to the third possible implementation manner of the second aspect, in a fourth possible implementation manner, the Layer 2 unit is further configured to, before transmitting the queued data packet to the physical layer, postpone an encryption operation of the PDCP or RLC layer to be performed at the media access control MAC layer.

In a third aspect, the application provides a terminal device for transmitting data, including a processor and a transmitter, where:

the processor is configured to, when a service is started, construct a virtual traffic flow template TFT by using service information, and map, by using the virtual TFT, a data packet of the service to a virtual bearer corresponding to the virtual TFT;

the processor is further configured to set the priority of the virtual bearer according to the priority of the service; and

the transmitter is configured to transmit the data packet to a network device on an actual bearer according to the priority of the virtual bearer transmitted by the processor.

In a first possible implementation manner of the third aspect, the service information is at least one of information about a port for receiving the service and the priority of the service.

With reference to the third aspect or the first possible implementation manner of the third aspect, in a second possible implementation manner, the transmitter has a built-in Layer 2 unit, where the Layer 2 unit is configured to queue the data packet in a bearer queue of the actual bearer according to the priority of the virtual bearer to obtain a queued data packet, and transmit the queued data packet to the physical layer, to enable a high-priority data packet preferentially transmitted to a network device at the physical layer.

With reference to the second possible implementation manner of the third aspect, in a third possible implementation manner, the Layer 2 unit is specifically configured to queue, by a Packet Data Convergence Protocol PDCP layer or radio link control RLC layer of the Layer 2 unit, the data packet in a bearer queue of the actual bearer according to the priority of the virtual bearer to obtain a queued data packet, and transmit the queued data packet to the physical layer, to enable a high-priority data packet preferentially transmitted to a network device at the physical layer.

With reference to the third possible implementation manner of the third aspect, in a fourth possible implementation manner, the Layer 2 unit is further configured to, before transmitting the queued data packet to the physical layer, postpone an encryption operation of the PDCP layer or the RLC layer to be performed at the media access control MAC layer.

The present invention introduces virtual multi-bearer on a terminal to simulate a multi-bearer QoS effect under the conditions that currently the multi-bearer environment is immature and a network does not support multi-bearer. In embodiments of the present invention, no actual end-to-end multi-bearer connection is established between a terminal and a network side, but the terminal, when locally transmitting a packet, simulates a multi-bearer mechanism to divide multiple virtual service channels on a non-guaranteed bit rate (Non-Guaranteed Bit Rate, Non-GBR) bearer and perform priority-based scheduling among the service channels. Through virtual multi-bearer, embodiments of the present invention balance service QoS with appropriate resource utilization under the condition that the network does not support the multi-bearer capability.

### BRIEF DESCRIPTION OF DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a flowchart of a method for transmitting data according to an embodiment of the application;

FIG. 2 is a flowchart of another method for transmitting data according to an embodiment of the application;

FIG. 3 is a flowchart of still another method for transmitting data according to an embodiment of the application;

FIG. 4 is a schematic structural diagram of a terminal device for transmitting data according to an embodiment of the application;

FIG. 5 is a schematic structural diagram of another terminal device for transmitting data according to an embodiment of the application;

FIG. 6 is a schematic structural diagram of a terminal device for transmitting data according to an embodiment of the application; and

FIG. 7 is a schematic structural diagram of another terminal device for transmitting data according to an embodiment of the application.

### DESCRIPTION OF EMBODIMENTS

The following clearly describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art according to the embodiments of the present invention without creative efforts shall fall within the protection scope of the present invention.

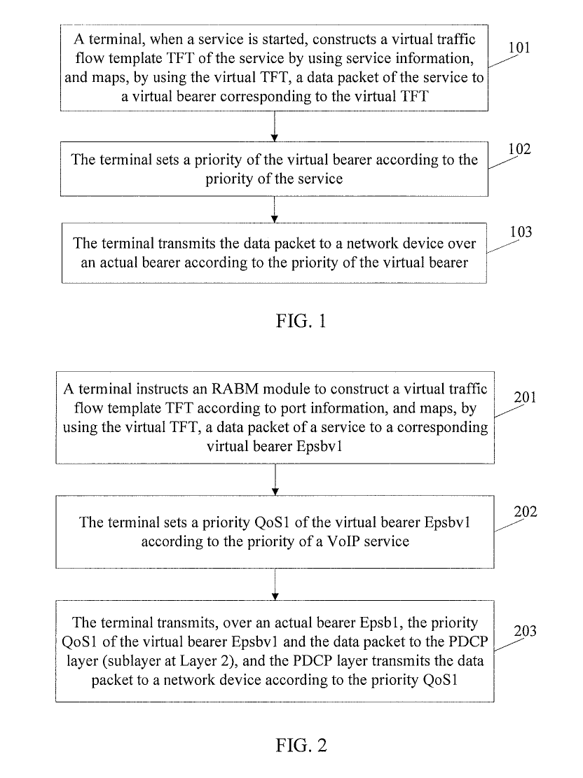

Referring to FIG. 1, FIG. 1 is a flowchart of a method for transmitting data according to an embodiment of the application, which includes the following steps:

101. A terminal, when a service is started, constructs a virtual traffic flow template TFT by using service information, and maps, by using the virtual TFT, a data packet of the service to a virtual bearer corresponding to the virtual TFT.

The service information can be at least one of information about a port for receiving a service and the priority of a service, or a parameter of any form in the TFT. The port information is preferable.

The service herein indicates a quasi real-time service. When a quasi real-time service is started, the terminal is triggered to establish multi-bearer to provide QoS support.

However, because the network side does not support multi-bearer, the terminal fails to establish multi-bearer. The quasi real-time service herein indicates that the started service is a service that is expected to run in real time or has high real-time requirements. However, because the network does not support the multi-bearer capability, real-time transmission of the service cannot be guaranteed. According to the method in this embodiment, a multi-bearer mechanism is simulated to make a service effect approximate a real-time service effect.

The traffic flow template (Traffic Flow Template, TFT) is a collection of data packet filters associated with an evolved packet system (Evolved Packet System, EPS) bearer. An uplink filter template (UpLink Traffic Flow Template, UL TFT) is a group of uplink data packet filters in the TFT, and a downlink filter template (DownLink Traffic Flow Template, DL TFT) is a group of downlink data packet filters in the TFT. Each dedicated bearer is associated with at least one TFT. A user equipment (User Equipment, UE), by using a UL TFT, maps uplink data to a TFT-associated bearer for transmission. A Protocol Data Unit GateWay (Protocol Data Unit GateWay, PDN GW), by using a DL TFT, maps downlink data to a TFT-associated bearer for transmission.

The virtual TFT is a virtual data packet filter. The virtual TFT may not be an actual filter that maps a data packet to an actual bearer, but is implemented through virtualization of an actual filter by the terminal that communicates with a network device not supporting a multi-bearer service. The virtualization process can be implemented by protocol stack software inside the terminal. The virtual TFT is used to map a data packet to a virtual bearer corresponding to the priority of the service according to the priority of the service including the data packet.

In this embodiment, no actual end-to-end multi-bearer connection is established and the data packet is not mapped to a corresponding virtual bearer for transmission. The virtual bearer is to simulate, only when the terminal locally transmits a data packet, an existing multi-bearer mechanism to divide multiple virtual service channels on a bearer and perform priority-based scheduling among the service channels.

102. The terminal sets the priority of the virtual bearer according to the priority of the service.

The priority of the service is determined by the terminal and the network side according to a type of the service.

103. The terminal transmits the data packet to the network device on an actual bearer according to the priority of the virtual bearer.

Alternatively, the implementation manner for the terminal to transmit the data packet to the network device on an actual bearer according to the priority of the virtual bearer may be:

queuing, by Layer 2 of the terminal, the data packet in a bearer queue of the actual bearer according to the priority of the virtual bearer to obtain a queued data packet, and transmitting the queued data packet to the physical layer, to enable a high-priority data packet preferentially transmitted to the network device at the physical layer.

The implementation manner of queuing, by Layer 2 of the terminal, the data packet in a bearer queue of the actual bearer according to the priority of the virtual bearer may be:

queuing, by a Packet Data Convergence Protocol (Packet Data Convergence Protocol, PDCP) layer or radio link control (Radio Link Control, RLC) layer at Layer 2, the data packet in a bearer queue of the actual bearer according to the priority of the virtual bearer.

To improve an effect to approximate the multi-bearer scheduling and enable data packets of a high-priority service to be queued in the front of the queue as far as possible, an encryption operation of the PDCP layer or RLC layer at Layer 2 may be postponed to be performed at the media access control layer (Media Access Control, MAC) before a queued data packet is transmitted to the physical layer.

In this embodiment, under the condition that the network does not support multi-bearer, the terminal introduces virtual multi-bearer to simulate the multi-bearer QoS effect. No actual end-to-end multi-bearer connection is established between the terminal and the network side, but the terminal, when locally transmitting a data packet, simulates the multi-bearer mechanism to divide multiple virtual service channels on a bearer and perform priority-based scheduling among the service channels. The terminal locally distinguishes the service priority and transmits the data to the network according to the priority to implement differentiated service QoS and meet the QoS requirements of different service forms. Through virtual multi-bearer, this embodiment can balance service QoS with appropriate resource utilization under the condition that the network or terminal does not support the multi-bearer capability. This embodiment can be applied to a Long Term Evolution (Long Term Evolution, LTE) terminal system, a Universal Mobile Telecommunications (Universal Mobile Telecommunications System, UMTS) terminal system or another system where data packets need to queue and wait to be scheduled and transmitted.

Referring to FIG. 2, FIG. 2 is a flowchart of another method for transmitting data according to an embodiment of the application. This implementation is an application of the method according to the present invention in an LTE terminal system. The network does not support multi-bearer and the terminal establishes a default bearer after dialing up. The default bearer is named Epsb1 and the corresponding wireless bearer is named DRB1. Session initiation protocol (Session Initiation Protocol, SIP) video communication software, after being started, attempts to establish a dedicated bearer for a voice over Internet phone (Voice over Internet Phone, VoIP) service, but is rejected by the network side. The method includes the following steps:

201. The terminal instructs a radio access management module (Radio Access Bearer Management, RABM) to construct a virtual traffic flow template TFT according to port information, and maps a data packet of a service to a corresponding virtual bearer Epsbv1 by using the virtual TFT.

VoIP services may be divided into video services and voice services. The terminal constructs different virtual TFTs according to ports processing different services. The ports here refer to protocol ports through which the terminal transmits and receives data packets of various services included in the VoIP service by using the TCP/IP protocol.

202. The terminal sets a priority QoS1 of the virtual bearer Epsbv1 according to the priority of the VoIP service.

203. The terminal transmits the priority QoS1 of the virtual bearer Epsbv1 and the data packet to the PDCP layer (a sublayer of Layer 2) on the actual bearer Epsb1, and the PDCP layer transmits the data packet to the network device according to the priority QoS1.

The terminal transmits the priority QoS1 of the virtual bearer Epsbv1 and the data packet to the PDCP layer. After receiving the data packet, the PDCP layer queues the data packet at an appropriate position according to the priority QoS1 instead of simply queuing the data packet at the rear of the DRB1 queue. When the MAC layer obtains air interface resources for scheduling and packet assembly, VoIP service data, queued in the front of the queue, is first scheduled and transmitted to the network device.

The service priority, as the basis of queuing and scheduling, is the purpose of constructing the virtual TFT and establishing the virtual bearer. For scheduling of radio resources, each priority is similar to a data radio bearer (Data Radio Bearer, DRB) of multi-bearer. The difference lies in that DRB scheduling is implemented at the MAC layer while service priority scheduling is implemented at the PDCP layer.

When a service uses multiple ports, the terminal iterates the preceding process to establish multiple virtual TFTs and multiple virtual bearers. In the embodiment, an SIP video communication service uses a total of five ports. Actually, five virtual TFTs are configured, three virtual bearers are established, and three different service priorities are allocated. The priorities of the virtual TFTs are higher than those of other common TFTs so that the service data preferentially matches the virtual TFTs.

Taking the application in the LTE terminal system as an example, this embodiment describes the method of the present invention. In this embodiment, the multi-bearer QoS effect is simulated by adopting virtual multi-bearer on the terminal under the condition that the network does not support multi-bearer. No actual end-to-end multi-bearer connection is established between the terminal and the network side, but the terminal, when locally transmitting a data packet, simulates a multi-bearer mechanism to divide multiple virtual service channels on a default bearer and perform priority-based scheduling among the service channels. Through virtual multi-bearer, this embodiment can balance service QoS with appropriate resource utilization under the condition that the network or terminal does not support the multi-bearer capability.

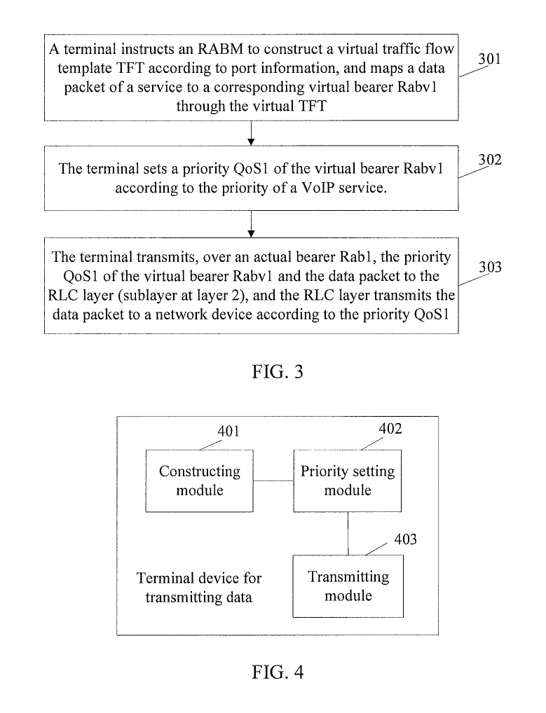

Referring to FIG. 3, FIG. 3 is a flowchart of still another method for transmitting data according to an embodiment of the application. This embodiment is an application of the method according to the present invention in a UMTS terminal system, which includes:

301. The terminal instructs an RABM to construct a virtual traffic flow template TFT according to port information, and maps a data packet of a service to a corresponding virtual bearer Rabv1 by using the virtual TFT.

302. The terminal sets a priority QoS1 of the virtual bearer Rabv1 according to a priority of a VoIP service.

303. The terminal transmits, on an actual bearer Rab1, the priority QoS1 of the virtual bearer Rabv1 and the data packet to the RLC layer (a sublayer of Layer 2), and the RLC layer transmits the data packet to a network device according to the priority QoS 1.

The main difference between this embodiment and the embodiment shown in FIG. 2 lies in Layer 2 processing. The PDCP layer does not support retransmission and therefore does not support a PDCP serial number (Serial Number, SN). As a result, the priority queuing is moved downwards from the PDCP layer to the RLC layer for processing.

To gain an approximate multi-bearer scheduling effect, a high-priority service packet is queued in the front of a queue as far as possible and the process from an RLC service data unit (Service Data Unit, SDU) to an RLC protocol data unit (Protocol Data Unit, PDU) is postponed. Under the premise that the data amount for MAC scheduling within a certain period is ensured, the RLC SDU is divided for an encryption operation as late as possible.

This embodiment takes the application in the UMTS terminal system as an example to describe the method of the present invention. In this embodiment, the terminal introduces virtual multi-bearer to simulate the multi-bearer QoS effect under the condition that the network does not support multi-bearer. No actual end-to-end multi-bearer connection is established between the terminal and the network side, but the terminal, when locally transmitting a data packet, simulates a multi-bearer mechanism to divide multiple virtual service channels on a primary (Primary) bearer and perform priority-based scheduling among the service channels. Through virtual multi-bearer, this embodiment can balance service QoS with appropriate resource utilization under the condition that the network or terminal does not support the multi-bearer capability.

Referring to FIG. 4, FIG. 4 is a schematic structural diagram of a terminal device for transmitting data according to an embodiment of the application, including a constructing module 401, a priority setting module 402, and a transmitting module 403.

The constructing module 401 is configured to, when a service is started, construct a virtual traffic flow template TFT by using service information, and map, by using the virtual TFT, a data packet of the service to a virtual bearer corresponding to the virtual TFT.

The service information can be at least one of information about a port for receiving the service and the priority of the service, or a parameter of any form in the TFT. The port information is preferable.

The virtual TFT may not be an actual filter that maps a data packet to an actual bearer, but is implemented through virtualization of an actual filter by the terminal that is served by a network not supporting multi-bearer services. The virtualization process can be implemented by protocol stack software inside the terminal.

The priority setting module 402 is configured to set the priority of the virtual bearer according to the priority of the service.

The transmitting module 403 is configured to transmit the data packet to a network device on the actual bearer according to the priority of the virtual bearer set by the priority setting module 402.

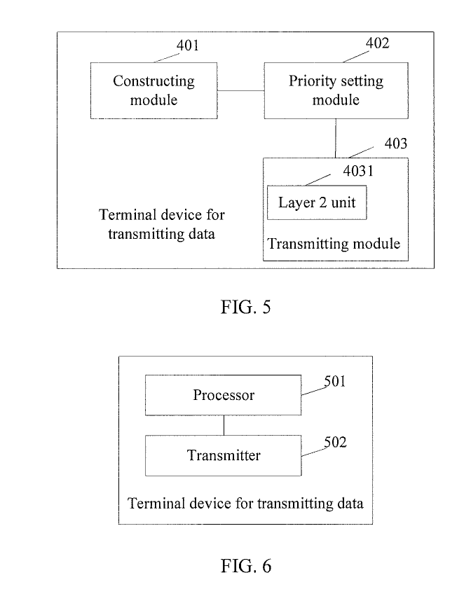

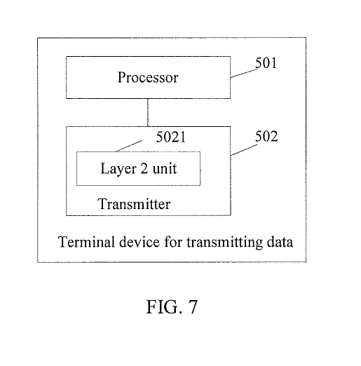

Alternatively, the transmitting module 403 may include a Layer 2 unit 4031, as shown in FIG. 5.

The Layer 2 unit 4031 is configured to queue a data packet in a bearer queue of the actual bearer according to the priority of the virtual bearer to obtain a queued data packet, and transmit the queued data packet to the physical layer, to enable a high-priority data packet preferentially transmitted to a network device at the physical layer.

The Layer 2 unit 4031 is specifically configured to queue, by the Packet Data Convergence Protocol PDCP layer or radio link control RLC layer of the Layer 2 unit, a data packet in a bearer queue of the actual bearer according to the priority of the virtual bearer to obtain a queued data packet, and transmit the queued data packet to the physical layer, to enable a high-priority data packet preferentially transmitted to a network device at the physical layer.

The Layer 2 unit 4031 is further configured to, before transmitting the queued data packet to the physical layer, postpone an encryption operation of the PDCP layer or RLC layer to be performed at the media access control MAC layer.

The terminal device for transmitting data provided in this embodiment introduces virtual multi-bearer to simulate the multi-bearer QoS effect under the condition that the network does not support multi-bearer. No actual end-to-end multi-bearer connection is established between the terminal device for transmitting data and the network side, but the terminal device for transmitting data, when locally transmitting a data packet, simulates a multi-bearer mechanism to divide multiple virtual service channels on a bearer and perform priority-based scheduling among the service channels. The terminal locally distinguishes a service priority and, according to the priority, transmits the data to the network to implement differentiated service QoS and meet the QoS requirements of different service forms. Through virtual multi-bearer, this embodiment can balance service QoS with appropriate resource utilization under the condition that the network or the terminal device for transmitting data does not support the multi-bearer capability. The terminal device for transmitting data described in this embodiment may be applied to an LTE terminal system or a UTMS terminal system, and may also be applied to another system in which data packets need to queue and wait to be scheduled and transmitted.

Referring to FIG. 6, FIG. 6 is a schematic structural diagram of a terminal device for transmitting data according to an embodiment of the application, including a processor 501 and a transmitter 502.

The processor 501 is configured to, when a service started, construct a virtual traffic flow template TFT by using service information, and map, by using the virtual TFT, a data packet of the service to a virtual bearer corresponding to the virtual TFT.

The service information can be at least one of information about a port for receiving the service and the priority of the service, or a parameter of any form in the TFT. The port information is preferable.

The processor 501 is further configured to set the priority of the virtual bearer according to the priority of the service.

The transmitter 502 is configured to transmit the data packet to a network device on an actual bearer according to the priority of the virtual bearer transmitted by the processor 501.

The processor 502 has a built-in Layer 2 unit 5021, where the Layer 2 unit 5021 is configured to queue a data packet in a bearer queue of the actual bearer according to the priority of the virtual bearer to obtain a queued data packet, and transmit the queued data packet to the physical layer, to enable a high-priority data packet preferentially transmitted to a network device at the physical layer.

Alternatively, the Layer 2 unit 5021 may be a central processing unit (Central Processing Unit, CPU), a microprocessor, a controller, and the like.

The Layer 2 unit 5021 is specifically configured to queue, by the PDCP layer or RLC layer of the Layer 2 unit 5021, a data packet in a bearer queue of the actual bearer according to the priority of the virtual bearer to obtain a queued data packet, and transmit the queued data packet to the physical layer, to enable a high-priority data packet preferentially transmitted to a network device at the physical layer.

Alternatively, the Layer 2 unit 5021 is further configured to, before transmitting the queued data packet to the physical layer, postpone an encryption operation of the PDCP layer or RLC layer to be performed at the media access control MAC layer.

The terminal device for transmitting data provided in this embodiment introduces virtual multi-bearer to simulate the multi-bearer QoS effect under the condition that the network does not support multi-bearer. No actual end-to-end multi-bearer connection is established between the terminal device for transmitting data and the network side, but the terminal device for transmitting data, when locally transmitting a data packet, simulates a multi-bearer mechanism to divide multiple virtual service channels on a bearer and perform priority-based scheduling among the service channels. The terminal locally distinguishes a service priority and, according to the priority, transmits the data to the network to implement differentiated service QoS and meet the QoS requirements of different service forms. Through virtual multi-bearer, this embodiment can balance service QoS with appropriate resource utilization under the condition that the network or the terminal device for transmitting data does not support the multi-bearer capability. The terminal device for transmitting data described in this embodiment may be applied to an LTE terminal system or a UTMS terminal system, and may also be applied to another system in which data packets need to queue and wait to be scheduled and transmitted.

Persons of ordinary skill in the art should understand that all or a part of the steps of the method according to the embodiments may be implemented by a computer program instructing relevant hardware. The program may be stored in a computer readable storage medium. When the program is run, the steps of the method according to the embodiments are performed. The storage medium may be a magnetic disk, an optical disc, a read-only memory (Read-Only Memory, ROM), or a random access memory (Random Access Memory, abbreviated as RAM).

The foregoing is merely exemplary embodiment of the present invention. However, the protection scope of the present invention is not limited thereto. Therefore, equivalent changes derived according to the claims of the present invention shall fall within the protection scope of the present invention.

What is claimed is:

1. A method for transmitting data, comprising:
when a service is started, constructing, by a terminal, a virtual traffic flow template TFT by using service information, and mapping, by using the virtual TFT, a data packet of the service to a virtual bearer corresponding to the virtual TFT;
setting, by the terminal, a priority of the virtual bearer according to a priority of the service; and
transmitting, by the terminal, the data packet to a network device on an actual bearer according to the priority of the virtual bearer.

2. The method for transmitting data according to claim 1, wherein the service information is at least one of information about a port for receiving the service and the priority of the service.

3. The method for transmitting data according to claim 1, wherein the transmitting, by the terminal, the data packet of the service to a network device on an actual bearer according to the priority of the virtual bearer comprises:
queuing, by Layer 2 of the terminal, the data packet in a bearer queue of the actual bearer according to the priority of the virtual bearer to obtain a queued data packet, and transmitting the queued data packet to a physical layer, to enable a high-priority data packet preferentially transmitted to the network device at the physical layer.

4. The method for transmitting data according to claim 3, wherein the queuing, by Layer 2 of the terminal, the data packet in a bearer queue of the actual bearer according to the priority of the virtual bearer comprises:
queuing, by Packet Data Convergence Protocol PDCP layer or radio link control RLC layer of the Layer 2, the data packet in the bearer queue of the actual bearer according to the priority of the virtual bearer.

5. The method for transmitting data according to claim 4, wherein before the transmitting the queued data packet to the physical layer, the method further comprises:
postponing an encryption operation of the PDCP or RLC layer at the Layer 2 to be performed at a media access control MAC layer.

6. A terminal device for transmitting data, comprising:
a constructing module, configured to, when a service is started, construct a virtual traffic flow template TFT by using service information, and map, by using the virtual TFT, a data packet of the service to a virtual bearer corresponding to the virtual TFT;
a priority setting module, configured to set a priority of the virtual bearer according to a priority of the service; and
a transmitting module, configured to transmit the data packet to a network device according to the priority of the virtual bearer set by the priority setting module.

7. The terminal device for transmitting data according to claim 6, wherein the service information is at least one of information about a port for receiving the service and the priority of the service.

8. The terminal device for transmitting data according to claim 6, wherein the transmitting module comprises:
a Layer 2 unit, configured to queue the data packet in a bearer queue of the actual bearer according to the priority of the virtual bearer to obtain a queued data packet, and transmit the queued data packet to a physical layer, to enable a high-priority data packet preferentially transmitted to a network device at the physical layer.

9. The terminal device for transmitting data according to claim 8, wherein the Layer 2 unit is specifically configured to queue, by Packet Data Convergence Protocol PDCP layer or radio link control RLC layer of the Layer 2 unit, the data packet in the bearer queue of the actual bearer according to the priority of the virtual bearer to obtain the queued data packet, and transmit the queued data packet to the physical layer, to enable the high-priority data packet preferentially transmitted to the network device at the physical layer.

10. The terminal device for transmitting data according to claim 9, wherein the Layer 2 unit is further configured to, before transmitting the queued data packet to the physical layer, postpone an encryption operation of the PDCP or RLC layer to be performed at a media access control MAC layer.

11. A terminal device for transmitting data, comprising a processor and a transmitter, wherein:
the processor is configured to, when a service is started, construct a virtual traffic flow template TFT by using service information, and map, by using the virtual TFT, a data packet of the service to a virtual bearer corresponding to the virtual TFT;
the processor is further configured to set a priority of the virtual bearer according to a priority of the service; and
the transmitter is configured to transmit the data packet to a network device on an actual bearer according to the priority of the virtual bearer transmitted by the processor.

12. The terminal device for transmitting data according to claim 11, wherein the service information is at least one of information about a port for receiving the service and the priority of the service.

13. The terminal device for transmitting data according to claim 11, wherein the transmitter has a built-in Layer 2 unit, wherein the Layer 2 unit is configured to queue the data packet in a bearer queue of the actual bearer according to the priority of the virtual bearer to obtain a queued data packet, and transmit the queued data packet to a physical layer, to enable a high-priority data packet is preferentially transmitted to a network device at the physical layer.

14. The terminal device for transmitting data according to claim 13, wherein the Layer 2 unit is specifically configured to queue, by Packet Data Convergence Protocol PDCP layer or radio link control RLC layer of the Layer 2 unit, the data packet in the bearer queue of the actual bearer according to the priority of the virtual bearer to obtain the queued data packet, and transmit the queued data packet to the physical layer, to enable the high-priority data packet preferentially transmitted to the network device at the physical layer.

15. The terminal device for transmitting data according to claim 14, wherein the Layer 2 unit is further configured to, before transmitting the queued data packet to the physical layer, postpone an encryption operation of the PDCP or RLC layer to be performed at a media access control MAC layer.
